(19) United States
(12) Patent Application Publication
(10) Pub. No.: US 2021/0231231 A1
(43) Pub. Date: Jul. 29, 2021

(54) PINCH VALVE MONITORING

(71) Applicant: FEELIT TECHNOLOGIES LTD., Haifa (IL)

(72) Inventors: Meital BAR, Yokneam Ilit (IL); Joji KAZAMA, Miyazaki (JP); Oded Shlomo KRAFT-OZ, Haifa (IL); Shinya KIMURA, Miyazaki (JP); Gady KONVALINA, Misgav (IL); Amit LEVY-YAMAMORI, Haifa (IL)

(21) Appl. No.: 17/050,873

(22) PCT Filed: Apr. 23, 2019
(86) PCT No.: PCT/IB19/53321

§ 371 Date: Oct. 27, 2020

Related U.S. Application Data
(60) Provisional application No. 62/663,276, filed on Apr. 27, 2018.

(51) Int. Cl. F16K 37/00; F16K 7/04

(52) U.S. Cl. CPC F16K 37/0083; F16K 7/04

(57) ABSTRACT

A method for monitoring a pinch valve, the method may include sensing an electrical parameter of at least one flexible sensor during a monitoring period to provide multiple values of the sensed electrical parameter; wherein the at least one flexible sensor comprises piezoresistive nanomaterials, wherein the piezoresistive nanomaterials are directly coupled to a flexible conduit of the pinch valve; wherein the sensed electrical parameter is indicative of a flexible conduit parameter selected out of stress and pressure; and estimating, based on the multiple values of the sensed electrical parameter, a state of the pinch valve.

### CROSS REFERENCE

This application claims priority from US provisional patent 62/663,276 filing date Apr. 27, 2018 which is incorporated herein by its entirety.

### BACKGROUND

Pinch valves are one of the most important assets at industrial plants as they are the devices that regulate gas or fluid in industrial equipment. Pinch valves are often subjected to performance issues based on environmental conditions (temperature, dust, or vibration), process characteristics (fluid corrosiveness, abrasiveness, or temperature), age (time in service), or usage (number of cycles).

The initial price of a pinch valve is much less compared to its maintenance costs.

The majority of pinch valves are subject to frequent, unnecessary, or costly maintenance inspections that often require the equipment to be shut down for maintenance. Reactive maintenance is the conventional and rapid approach for fixing or replacing parts of industrial equipment when it breaks down. There is a large unmet need to move away from reactive and seek predictive strategies for the maintenance of pinch valves.

Systems and methods for testing a pinch valve using pinch valve signatures were presented before, however, no description of sensors attached to the rubber component or stain-based analysis was described as the basis of the pinch valve signature. The common way to control and monitor the pinch valve is by using a pinch valve positioner, which is additional part to the valve itself, and it is limited to provide only an indirect and less accurate monitoring of the pinch valve operation.

There is a growing need to provide an accurate and cost effective methods for measuring the stage of pinch valves.

### SUMMARY

There may be provided a pinch valve monitoring method, array of flexible sensors and a kit, as illustrated in the specification and/or claims and/or drawings.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B illustrate an example of a pinch valve and a tested area of the pinch valve;

FIGS. 2A-2E illustrate examples of an array of flexible sensors, an array of flexible sensors that is attached to a flexible tube and a response of the array of flexible sensors;

FIGS. 3A-3B illustrate examples of an array of flexible sensors and an array of flexible sensors that is attached to a flexible tube;

FIGS. 4A-4B illustrate examples of an array of flexible sensors and an array of flexible sensors that is attached to a flexible tube;

FIGS. 5A-5C illustrate examples of an array of flexible sensors that is attached to a flexible tube and a response of the array of flexible sensors;

FIGS. 6-7 illustrate examples of a response of the array of flexible sensors;

FIGS. 8A-8G illustrate examples of an array of flexible sensors, foreign matters and responses of the array of flexible sensors;

FIG. 9 illustrates examples of a response of the array of flexible sensors;

FIGS. 10A-10C illustrates examples of a response of the array of flexible sensors and a derivative of the response;

FIGS. 11A-11B illustrate examples of an array of flexible sensors that is attached to a flexible tube;

FIGS. 12A-12E illustrate examples of a response of the array of flexible sensors;

FIGS. 13A-13B illustrate examples of a various analysis applied on the response of the array of flexible sensors;

FIGS. 14A-14c illustrate examples of the response of the array of flexible sensors;

FIG. 15 illustrates an examples of a process;

FIG. 16 illustrates an examples of a tables; and

FIG. 17 illustrates an example of a method.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a system should be applied mutatis mutandis to a method that can be executed by the system.

The following text may refer to piezoresistive nanoparticles. Piezoresistive nanoparticles are a non-limiting example of piezoresistive nanomaterials.

A new approach for monitoring valves and for providing real-time diagnostics may include directly sensing the valve part that undergoes deformation due to open close cycles.

For example, in pinch valve, the pinch tube is directly monitored by flexible sensors based on piezoresistive nanoparticles that are adhered to the tube or, printed directly on it. The advantage of this approach, in comparison with valves positioners are:
a. Reduced price.
b. Not effecting the valve size.
c. Direct detection of the valve components.
d. The price and size usually limit the use of these valves with positioners to the beginning and the end of the production line. Utilizing smart valves with flexible sensors will enable predictive maintenance in many types of valves, therefore, providing:
   i. Safer working environment—The fluids flowing inside of valve could be harmful (e.g., acids, organic gases, combustible gases). Sensing the health status of a valve can prevent unexpected accidents.
   ii. Reduce downtime of the production line due to unexpected problems
   iii. Save maintenance resources, raw materials, damage products and energy that are the outcome of malfunctioning valves.

There is provided at least one flexible sensor is printed directly or adhered on the flexible tube of the pinch valve and may be configured to sense shape, movement, pressure and stress directly on the flexible tube. Accordingly, the status (condition) of the pinch valve is diagnosed directly.

The suggested method will answer the abovementioned needs:
a. Smaller actuators and energy conservation due to thinner pinch tube well thickness that requires less energy to operate.
b. Self-diagnose valves and predictive maintenance.
c. Avoid risk of thinned pinch tube by attaching sensors that alert risks in a thinner pinch tube.
d. Safe and Secure working space thanks to predictive maintenance that allow the replacement of damage pinch tube before burst or safety even occurs.
e. Yielding new insights on the process.

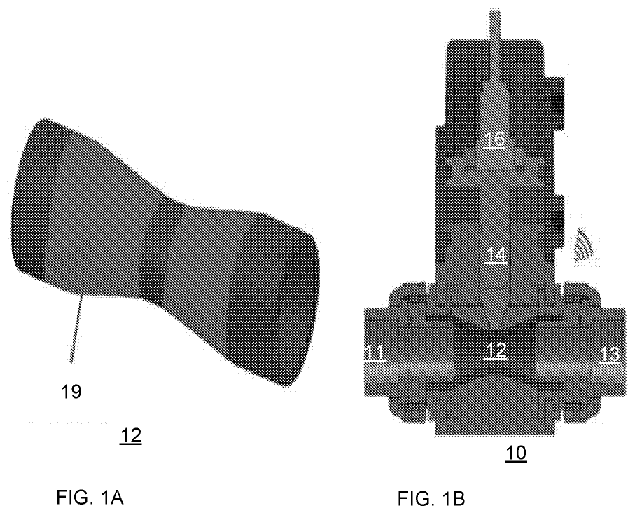

FIGS. 1A and 1B illustrate an example of a smartification of a pinch valve by attaching a flexible sensor 30 to a flexible tube 12 of the pinch valve 10.

FIG. 1A illustrates a region 19 of the flexible tune on which the piezoresistive nanoparticles of the at least one flexible sensor is attached or are printed on. The at least one flexible sensor are configured to sense shape, movement, pressure, stress directly on the flexible tube.

FIG. 1B is a cross sectional view of the pinch valve—and illustrated input 11, output 13, pinching element 14 and piston 16.

Piston 16 may move upwards and downwards and controls the position of the pinching element 14. The position of the pinching element 14 determines the openness of the flexible tube 12. Thus, when the pinch valve 10 is open the pinching element 14 does not press against the flexible tube 12. When pinch valve 10 is closed, the pinching element 14 presses the top of the flexible tube 12 against the bottom of the flexible tube 12 to prevent a passage of fluid through the flexible tube 12.

Each flexible sensor may include piezoresistive nanoparticle such as gold nanoparticles (GNPs) that may be included in a GNP ink. The GNP ink may be printed on at least one flexible substrate to form at least one flexible sensor that is highly sensitive to strain and/or pressure. The sensitivity of the at least one flexible sensor may resemble a sensitivity of the human skin at the finger tips (tens of milligrams). The at least one flexible sensor can be printed directly on the flexible tube of the pinch valve.

The at least one flexible sensor can be printed on 3D surfaces.

The at least one flexible sensor provides accurate and fast (millisecond) pressure/strain sensing with high resolution (tens of mg) and wide dynamic range.

The at least one flexible sensor exhibits high resolution (sub-millimeter) location sensing.

The at least one flexible sensor may perform multi-parameters sensing—pressure/strain, temperature and humidity

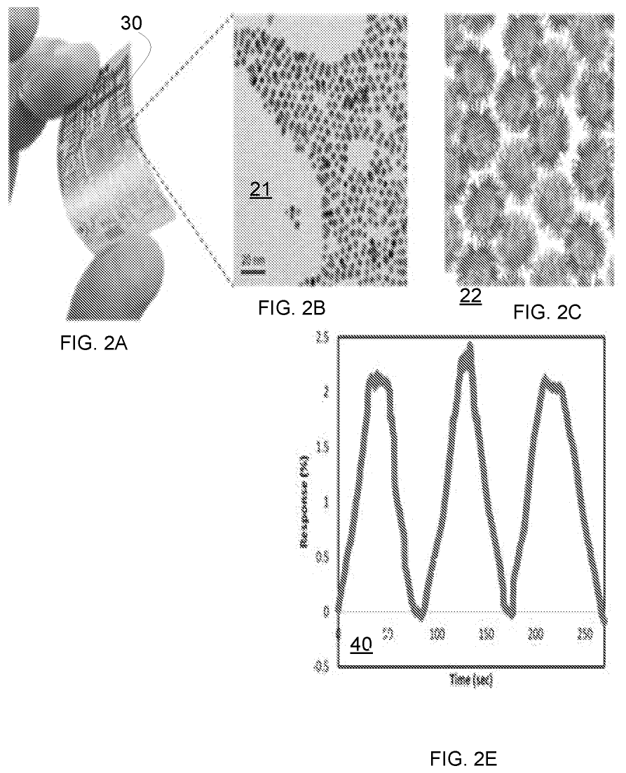

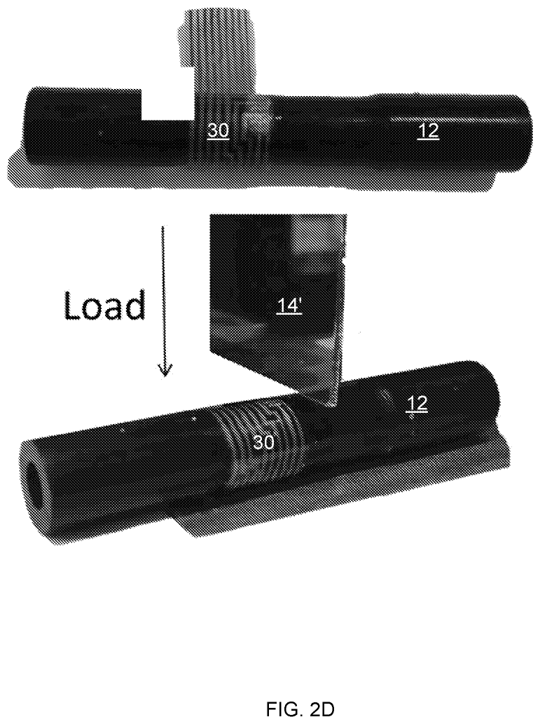

FIG. 2A illustrates an array of flexible sensors 30.

FIG. 2B is an example of a transmissive electron microscope (TEM) image 21 of gold nanoparticles of the flexible sensors.

FIG. 2C illustrates an image 22 of gold nanoparticles with organic molecules as a capping layer.

FIG. 2D illustrates the array of flexible sensors 30 that is adhered to a flexible tube 12 of pinch valve samples provided by Asahi and a load 14′.

FIG. 2E illustrates an example of a signal 40 obtained from a flexible sensor as a response to applied load (14′) from 0 to 600 KPa. The loading cycle was load-unload to zero force and was repeat three times. The load 14′ was applied as illustrated in FIG. 2D.

The array of flexible sensors 30 was manufactured by the following process:
a. The interdigitated electrodes were patterned on Kapton sheet with thickness ranging from 12 to 500 micron.
b. The spacing between the interdigitated electrodes is 150 micron and the electrodes width is 150 micron.
c. Gold nanoparticles ink was printed on interdigitated electrode structure to form resistors with average baseline resistances of 20 MegaOhm.
d. A post process curing is preforming to decrease the sensors resistance to 200-1000 KiloOhms.
e. After printing and curing the nanoparticles-based ink, the sensor was coated with a polymeric flexible coating with a thickness ranging from 10 to 200 micron.

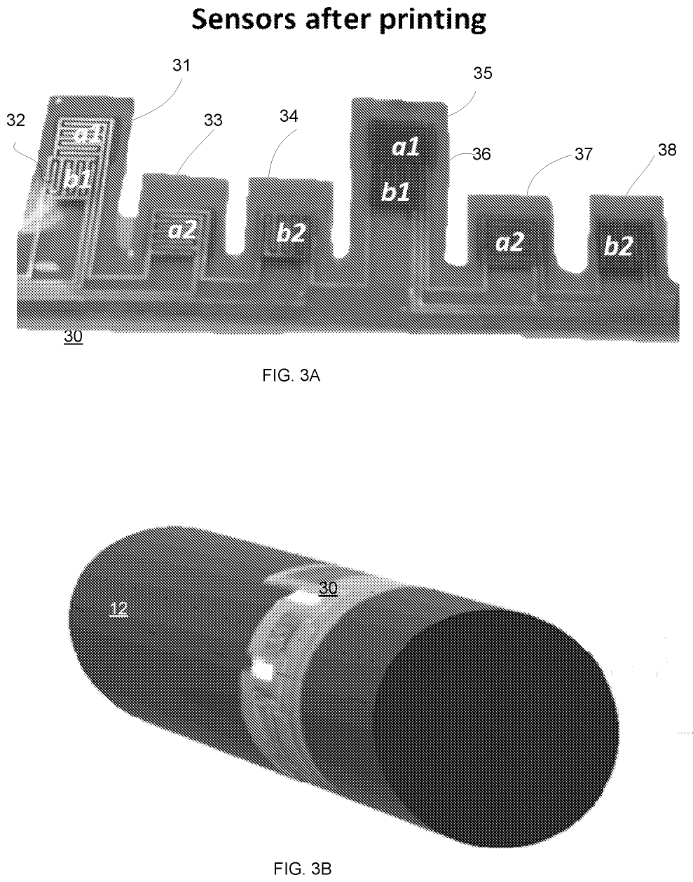

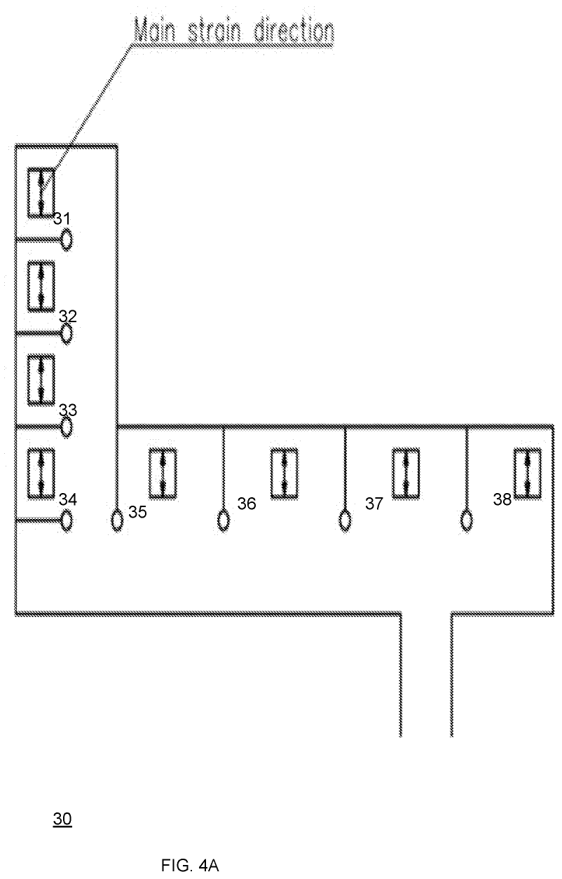

FIG. 3A illustrates array of flexible sensors 30 that includes eight flexible sensors 31, 32, 33, 34, 35, 36, 37 and 38. FIG. 3B illustrates the array of flexible sensors 30 as being glued to a flexible tube 12 of a pinch valve such as a rubber EPDM (ethylene propylene diene monomer rubber) tube with Pangofol All-Purpose Bonding Cements adhesive.

The flexible tube outer diameter was ten millimeter and the rubber thickness was one millimeter.

The size of each sensor flexible sensor was three by three millimeter.

The flexible sensors of the array of flexible sensors 30 have two sensing directionalities.

A first subset of flexible sensors (denoted a1 or a2) one has favorable sensing direction along the flow direction. The first subset includes first flexible sensor 31, third flexible sensor 33, fifth flexible sensor 35, and seventh flexible sensor 37.

A second subset of flexible sensors (denoted b1 or b2) one has favorable sensing direction that is perpendicular to the flow direction. The second subset includes second flexible sensor 32, fourth flexible sensor 34, sixth flexible sensor 36, and eighth flexible sensor 38.

Sensors are more sensitive to events (for example stress, strain) that occur along their favorable sensing direction. The shape and orientation of a sensor may determine its favorable sensing direction. For example—each flexible sensor may include two sets of fingers that are directed at a certain direction. Different finger directions provide different favorable sensing directions.

In addition, first flexible sensor 31, second flexible sensor 32, fifth flexible sensor 35 and sixth flexible sensor 36 are longer and are placed closer to the center of the tube in relation to the third flexible sensor 33, fourth flexible sensor 34, seventh flexible sensor 37 and eighth flexible sensor 38.

The first sensor 31, second sensor 32, fifth sensor 35 and sixth sensor 36 (denoted a1 or b1), have a higher response (in relation to the third flexible sensor 33, fourth flexible sensor 34, seventh flexible sensor 37 and eighth flexible sensor 38) to a compression of the flexible tube.

The dispersion of the flexible sensors on the flexible tube surface enables to provide pressure mapping on the tube.

The flexible sensors were used to sense the strains on the flexible tube during open/close cycles, flow changes and foreign matter propagation through the flexible tube.

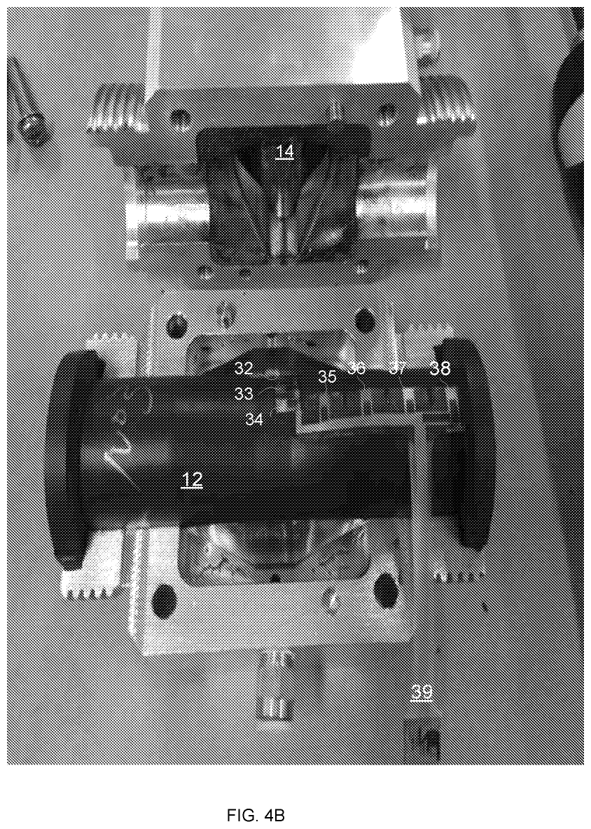

A different array of flexible sensors is described in FIG. 4A. FIG. 4B illustrates the sensors that are glued on flexible tube 12.

FIGS. 4A and 4B illustrate another arrangement of an array of sensors. The sensors of the array are adhered to a flexible tube 12 (as shown in FIG. 4B).

In FIG. 4B the flexible tube length is 100 mm, the outer diameter is 35 mm and the rubber thickness is 5 mm. The first till fourth sensors 31-34 are beneath the compressor with changing distance from the center of the tube (fourth sensor 34 at the tube center), and the fifth till eighth sensors 35-38 are positioned further away from the compressor and were subjected to less compressing strains.

This array of flexible sensors can be used as reference to other influence like flow. This array of flexible sensors was used for prediction of pinch valve rubber fatigue due to compression of actuators.

Sensitivity to Strain

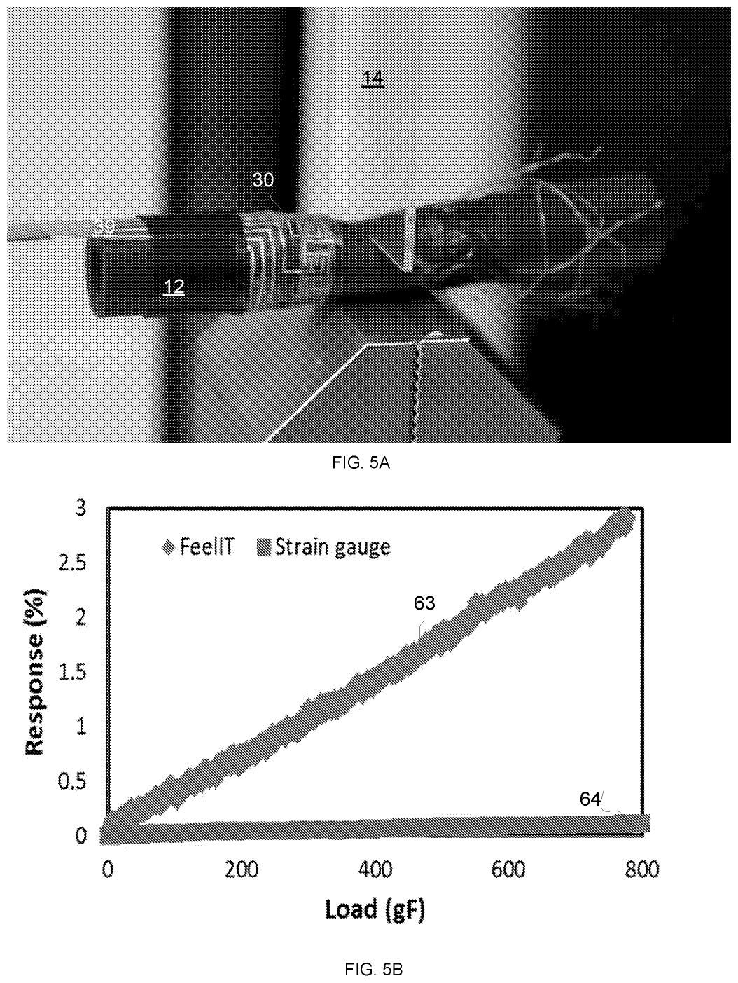

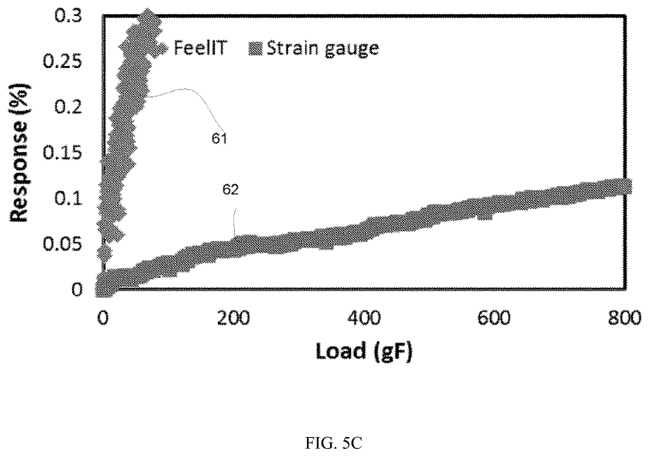

FIG. 5A illustrates a flexible tube 12 with an array of flexible sensors 30 that were glued to a left side of flexible tube 12. Conductors 39 coupled the flexible sensors of the array of flexible sensors 30 to a measurement unit (not shown). Load was applied at the center of the flexible tube during the test.

In FIG. 5A the flexible tube was adhered to a rubber EPDM (ethylene propylene diene monomer rubber) flexible tube with Pangofol All-Purpose Bonding Cements adhesive. The flexible tube outer diameter was 10 mm and the flexible tube thickness was 1 mm.

A metallic strain gauge (from KYOWA) was adhered to the right side of the tube and FIGS. 5B and 5C illustrates the improved sensitivity of the array of flexible sensors 30 in comparison to the sensitivity of the metallic strain gauge.

The array of flexible sensors 30 and the metallic strain gauge were located at opposite sides of the center of the flexible tube—at a distance of twenty millimeter from the center.

A glass slide 14 with one mm thickness applied force changing in a constant speed of 10 mm/min.

The load applied on the flexible tube was measured using Force Gauge Model M5-2 from Mark 10 load cell connected to the glass slide.

The change in the resistance of the array of flexible sensors and of the metallic strain gauge were measured with a digital multi-meter. The response was calculated by setting the baseline resistance as the resistance when no load is applied (R_{b}).

The resistance under a specific load is Rᵢ and the response is calculated by:

$$\frac{{R}_{i} - {R}_{b}}{{R}_{b}} .$$

In both FIGS. 5B and 5C the y-axis represents the response (in percent)—which is the change in conductivity of the array of flexible sensors or of the metallic strain gauge and the x-axis represents the load (between 0 and 800 gF).

In FIG. 5B curve 63 represents the sensitivity of the array of flexible sensors and curve 64 represents the sensitivity of the metallic strain gauge.

In FIG. 5C curve 61 represents the sensitivity of the array of flexible sensors and curve 62 represents the sensitivity of the metallic strain gauge.

In both figures the sensitivity of the array of flexible sensors is much higher (about thirty times more) than the sensitivity of the metallic strain gauge.

Response to Open Close Cycles

The pinch valve was repetitively opened and closed during the text. In addition, the flow of fluid to the valve was controlled to include flow periods in which fluid was send to the pinch valve and no flow periods in which fluid was not supplied to the pinch valve.

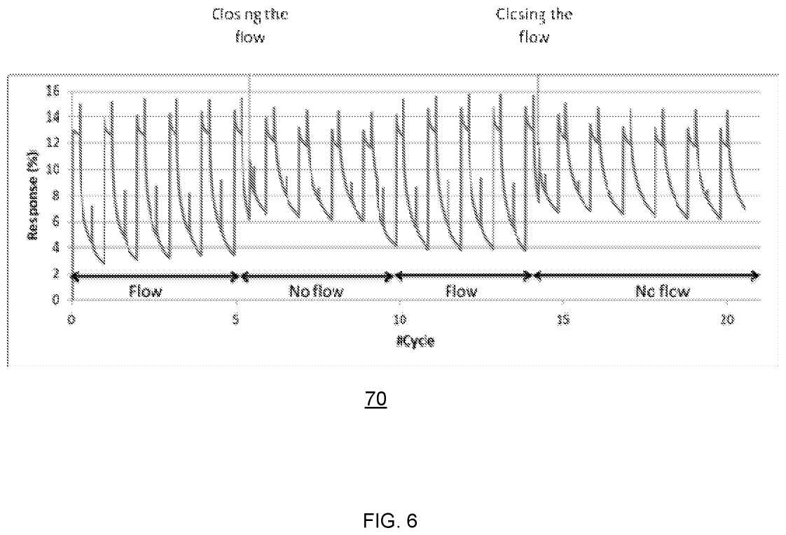

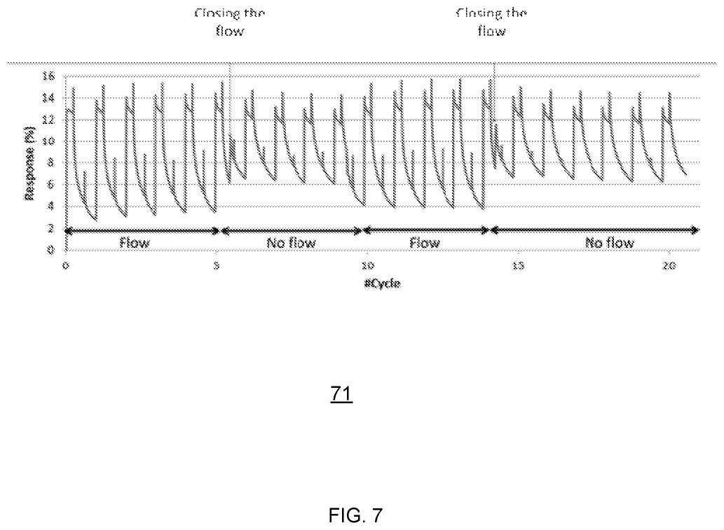

The response of the pinch valve to open close cycles was monitored by the array of flexible sensors and is presented (graph 70) in FIG. 6.

The first five open close cycles occurred during a first flow period. The sixth till tenth open close cycles occurred during a first no flow period.

The eleventh till fifteenth open close cycles occurred during a second flow period. The sixteenth till twentieth open close cycles occurred during a second no flow period.

Each open close cycle lasted few seconds. Other responses may be provided with different lengths of open close cycles.

The response of the pinch valve to open close cycles is characterized by:
a. Resistance increases during closing operation. The increase in resistance is a result of increased strain on the flexible tube surface.
b. Relaxion step is than followed, where the flexible tube is kept close but the strains on it slowly relaxed.
c. At the last step, the resistance of the nanoparticles-based sensors slowly returns to its initial value as the flexible tube is open and the strain is released.

Flow Identification

The indication of flow (through a pinch valve) may be significant in production line and is usually monitored with in-line pressure sensors.

In FIG. 7, the result of closing and opening the flow in pinch valve tube is demonstrated. The closed position was kept for two seconds and the open position was kept for five seconds. The opening and closing were repeated for 20 cycles. The starting point was with water flow in the pinch valve tube. After five cycles, the flow was closed. At the tenth cycle, the water flow was open again with similar pressure as in the initial five cycles. Finally, after fifteen cycles, the flow was closes again. The response to open close of the pinch valve tube is dramatically changed between flow and no flow Mainly the response amplitude is smaller when there is no flow. This result is related to the strains and pressures applied on the tube and sensed by the nanoparticles-based sensors. Specifically, during flow, there are pressures applied on the flexible tube, causing some expansion of the tube. During closing and opening the strain differences is larger for flow condition in comparison to no flow outcoming with a larger response amplitude. Flow/no flow positions were easily detected with all eight sensors of the array of flexible sensors 30 of FIG. 3A.

Foreign Matter Identification

Foreign matter indication is highly valvuable in production lines and there is no direct way to identify it. Foreign matter can cause the flow to continue during close status of the valve, cracks in the body of the tube, and in some industrie, like the pharmacutical industry, cross contamination that can greatly damage the product.

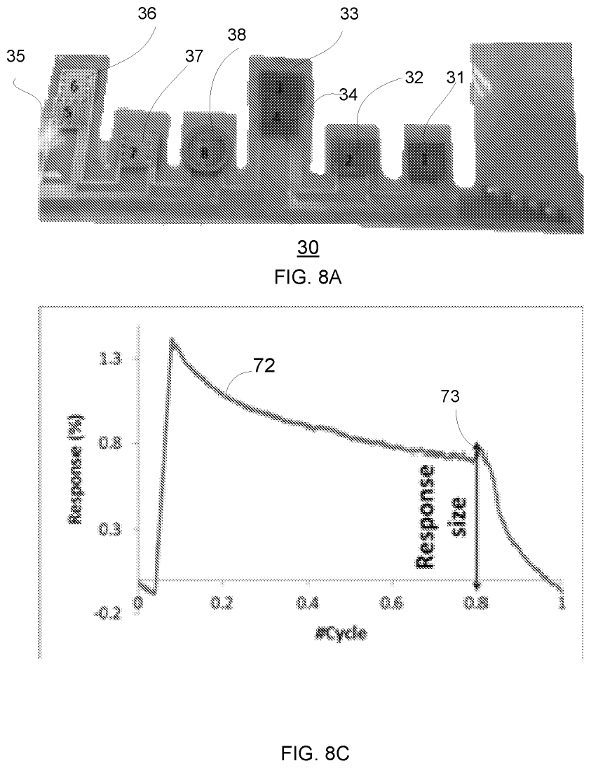

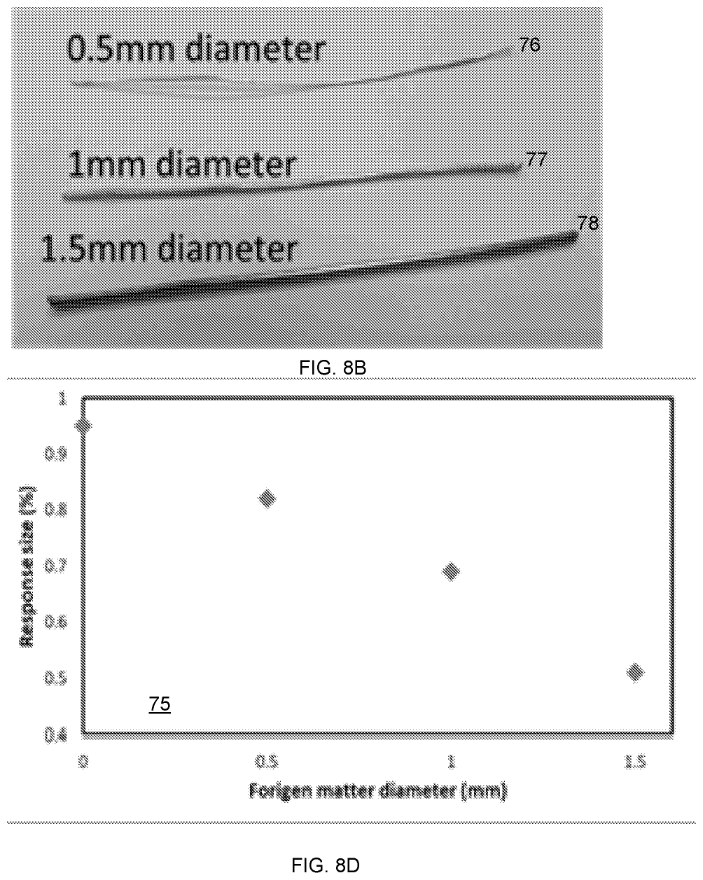

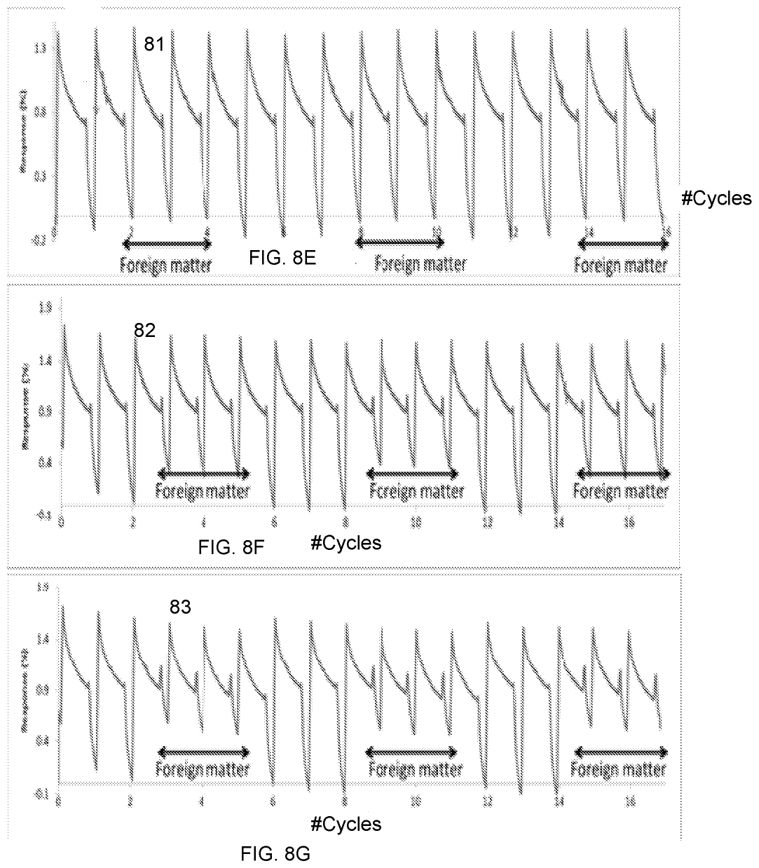

An array of flexible sensors 30 is illustrated in FIG. 8A. The array has the same arrangement of flexible sensor as the array of FIG. 3A, but the reference number associated with the different flexible sensors differs from those illustrated in FIG. 3A.

In FIG. 8A, the first flexible sensor 31 is the right most flexible sensor, the second flexible sensor 32 is located to the left of the first flexible sensor 31.

The third flexible sensor 33 and the fourth flexible sensor 34 are located to the left of the second flexible sensor 32—and both are closer to the center of the flexible tube. The third flexible sensor 33 is closer to the center than the fourth flexible sensor 34.

The eighth flexible sensor 38 is located to the left of the fourth flexible sensor 34 and substantially at the same line as the, first flexible sensor 31, second flexible sensor, and the seventh flexible sensor 37.

The seventh flexible sensor 37 is located to the left of the eighth flexible sensor 37.

The sixth flexible sensor 36 and the fifth flexible sensor 35 are located to the left of the seventh flexible sensor 37—and both are closer to the center of the flexible tube. The sixth flexible sensor 36 is closer to the center than the fifth flexible sensor 35.

The array of flexible sensors 30 may be printed on or glued to a flexible tube and may be configured to detect foreign matter that passes through the pinch valve.

In the following setup, the sensors that showed significant change in the presence of foreign matter where the sensors that their main sensing direction is perpendicular to the flow direction (for example first flexible sensor 31 and eighth flexible sensor 38).

FIG. 8B illustrates the forgien matter that was inserted to the pinch valve. The foreign matter include wires having diameters of 0.5 mm (wire 76), 1 mm (wire 77) and 1.5 mm (wire 78).

The response of the pinch valve was measured during repetitive open close cycles whereas the closed position was kept for two seconds and the open position was kept for five seconds.

FIG. 8C is a graph that includes a curve 72 that represents the response of the array of flexible sensors 30 to the insertion of one of the wires. A peak 73 towards the end of an open close period reflects the passage of the foreign particle through the pinch valve. The value of the peak was defined as the amplitude for the end of the closed cycle and the baseline resistance during open cycle. This peak might be related to the different strains that form when the pinch tube interacts with the wires when the valve is in closed position. When opening the valve, the relaxation of the tube is different compared with the relaxation when there is no wire.

FIG. 8D illustrates a linear relationship between the foreign matter diameter in millimeters (x-axis) of graph 75 and the response of the array of flexible sensor (y-axis).

FIGS. 8E, 8F and 8G include graphs 81, 82 and 83 that illustrate the response of the array of flexible sensors 30 for the insertion of wire 76, wire 77 and wire 78 during three open closed cycle each.

In all cases, the standard deviation was an order of magnitude smaller than the response size. From these results, it can be concluded that a foreign matter can be detected with nanoparticles-based sensors. The results showed meaningful change in the response size only for sensor with sensing direction that is perpendicular to the flow, therefore, foreign matter can be differentiated from other parameters like changes in the flow, since changes in the flow affect in a similar manner on all sensors.

FIGS. 8A-8G illustrate:
a. The sensor design that was used for foreign matter detection. The relevant sensor that shown a meaningful change in the response size because of the presence of a foreign matter were those with sensing direction that is perpendicular to the flow (first and eighth flexible sensors of FIG. 8A).
b. The wires that were inserted into the pinch valve's flexible tube.
c. Response size that was measured as the difference between the response at the end of the closed part of the operation cycle and the baseline resistance at the opened part of the operation cycle.
d. The response size as a function of the foreign matter diameter. Each point represents the average of at least nine values.
e. The responses of the eight flexible sensor to open close cycles in the presence of foreign matter with radii of 0.5 mm.
f. The responses of sensor 8 to open close cycles in the presence of foreign matter with radii of 1 mm.
g. The responses of sensor 8 to open close cycles in the presence of foreign matter with radii of 1.5 mm.

Prediction of pinch valve rubber fatigue due to compression of the compressor.

The response of the nanoparticles-based sensors is highly depended on the health status of the flexible tube. Specifically, a change in the response size is clear towards the end of life of the flexible tube.

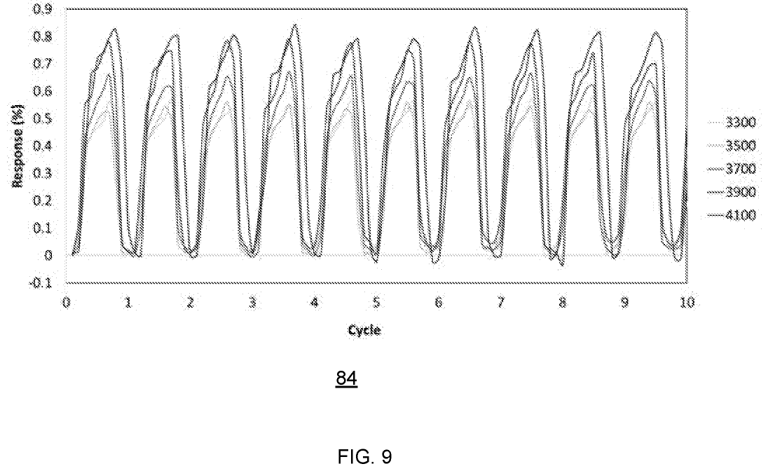

FIG. 9 includes a graph 84 that shows the response of a fourth flexible sensor (denoted 34 in FIG. 4) during open close cycles test of a pinch valve with an EPDM flexible tube. The pressure inside the pinch valve was 0.6 MPa. The temperature was 60° C. The flexible tube cracked after about 4200 cycles.

The graph includes five curves that represent the response of the pinch valve at five different time windows—each of ten open close cycles—wherein the different time windows start at different open close cycles—3300, 3500, 3700, 3900 and 4100 cycles. The response measured by the array of flexible sensors increases with increasing open close cycle s. This is an indication for increase elasticity and thinning of the rubber component of the flexible tube.

Sensors Sustainability

The stability and sustainability of the sensors to the flexible tube life time was tested by measuring the signal from the sensors while they are attached to the flexible tube in the valve in accelerated life test. The accelerated life test included 50 K and more open close cycles at 50° C. when the sensors were places far enough from the actuator (e.g., 1-2 cm away from the center) the sensors and the adhesion showed good stability over time.

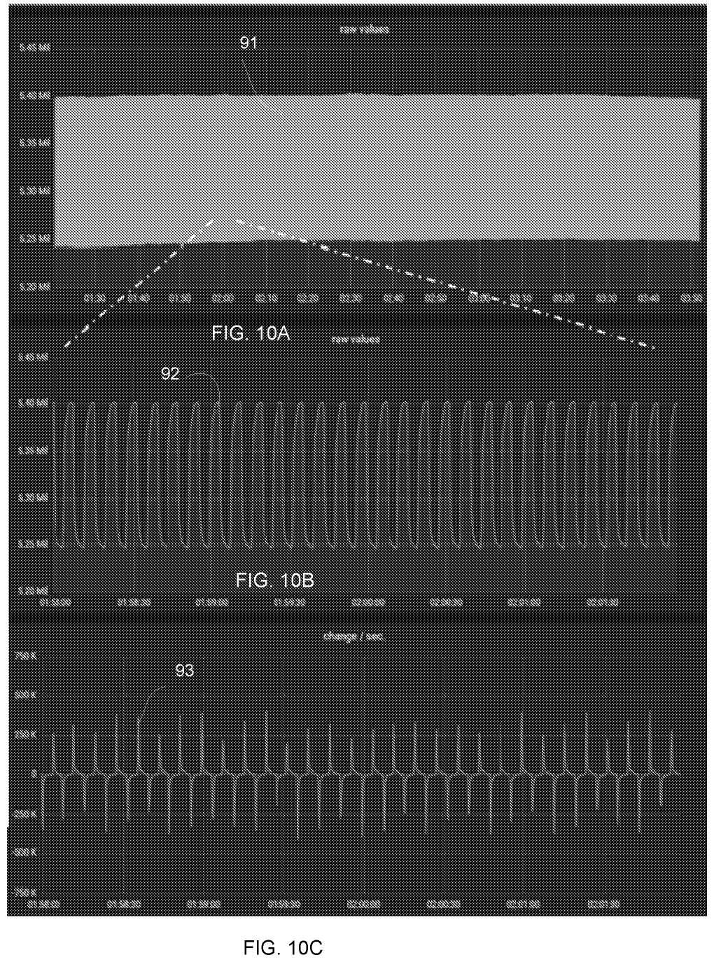

FIG. 10A shows a sample responses 91 recorded from the sixth sensor 36 of FIG. 3A adhered to an EPDM tube after about 100,000 open close cycles. Each cycle was eight seconds long—four second open and four second closed.

FIG. 10B illustrates some of the signals 92—at an expanded time scale.

FIG. 10C illustrates a derivative 93 of the signals of FIG. 10B.

FIGS. 10A-10C illustrate that the responses and signals are stable. The adhesion of the nanoparticles based sensors to the EPDM tube was examined visually.

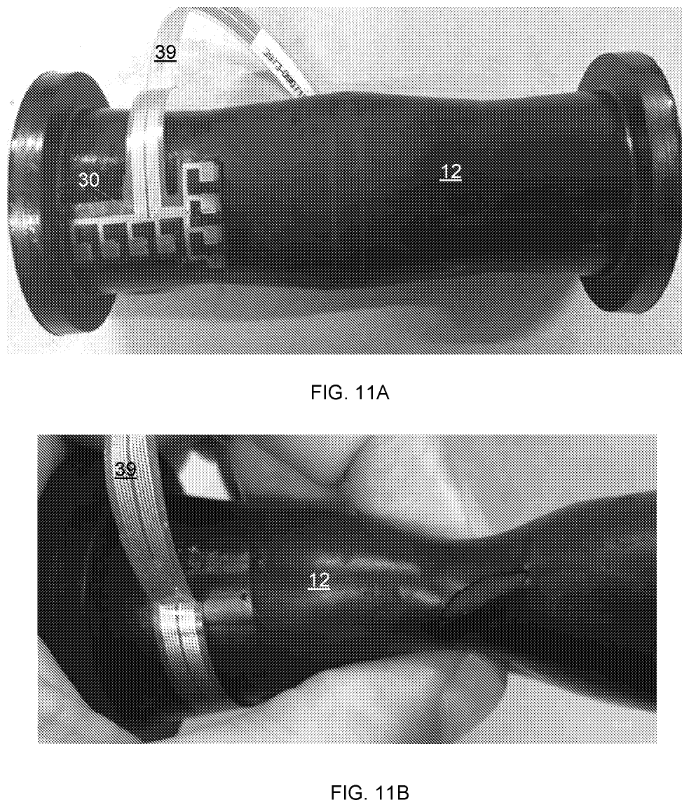

FIG. 11A, illustrates that the array of flexible sensors 30 remain attached to the flexible tube 12 after 156800 open close cycles.

FIG. 11B shows the formation of leakage 12′ in the flexible tube, therefore, the array of flexible sensors 30 withstand the lifetime of the tube.

Failure Prediction

The data set was based on 8 tubes based on FKM (fluoroelastomer materials) with 8 nanoparticles based sensors adhered to them. The adhesion of the piezoresistive nanomaterials based sensors to the FKM tube was performed with Pangofol All-Purpose Bonding Cements adhesive. The adhesion process included an overnight curing time. The tubes were placed in a pneumatic metal pinch valve in an incubator set for 50° C. as presented in FIG. 3A. Open close cycles were set as a constant time segment (e.g., 4 sec in open position and 4 sec in closed position). The data was sent to the cloud database via a wireless communication unit that was attached to the printed nanoparticles based sensors with a ZIF connector (Zero insertion force). The resistance of each of the eight sensors was recorded at 24 samples per second.

The resistance of the nanoparticles based sensor changes a result of:
a. The strains applied on the tube during pneumatic open close cycle s.
b. Changes in elastic properties of the FKM tube during pneumatic open close cycles.
c. Changes in the adhesion of the nanoparticles based sensors to the flexible tube.
d. Changes in the sensors over time

The setup was equipped with an external pressure sensor that detect the pressure drop inside the flexible tube in case of a leak and stops the pneumatic actuator. That way, the specific time of failure (e.g., burst of the flexible tube) can be detected, and the related responses of the nanoparticles based sensors can be correlated.

The methodology for burst prediction was Feature based analysis, and included: Data preparation, Overview, Cycles splitting, Feature selection, Feature engineering, PCA—Principle Component Analysis, training set, Modeling of burst prediction

Feature Selection and Engineering

Some features are general and represent general changes over time. For example, the amplitude recorded from the piezoresistive nanomaterial based sensors adhered to the pinched tube.

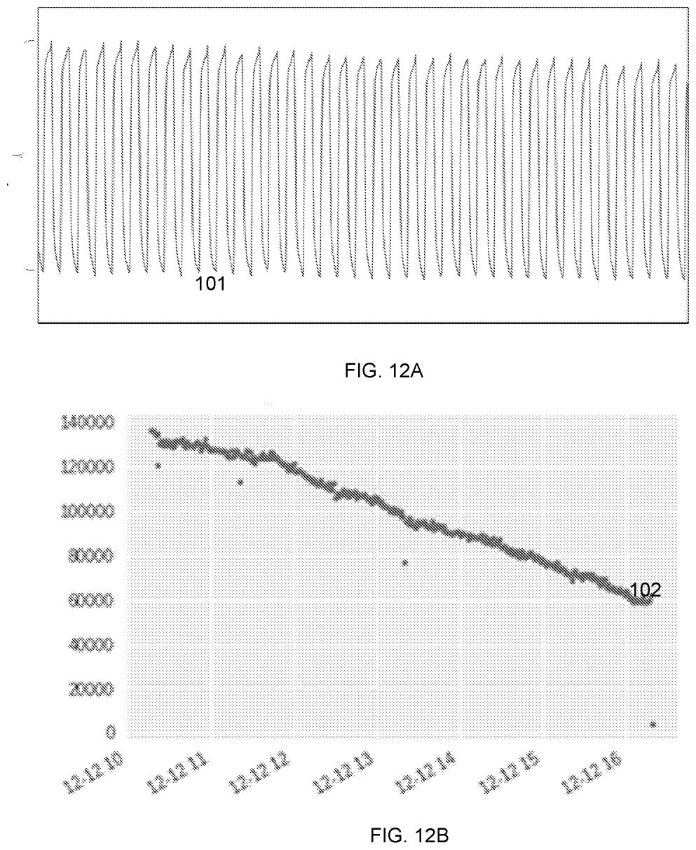

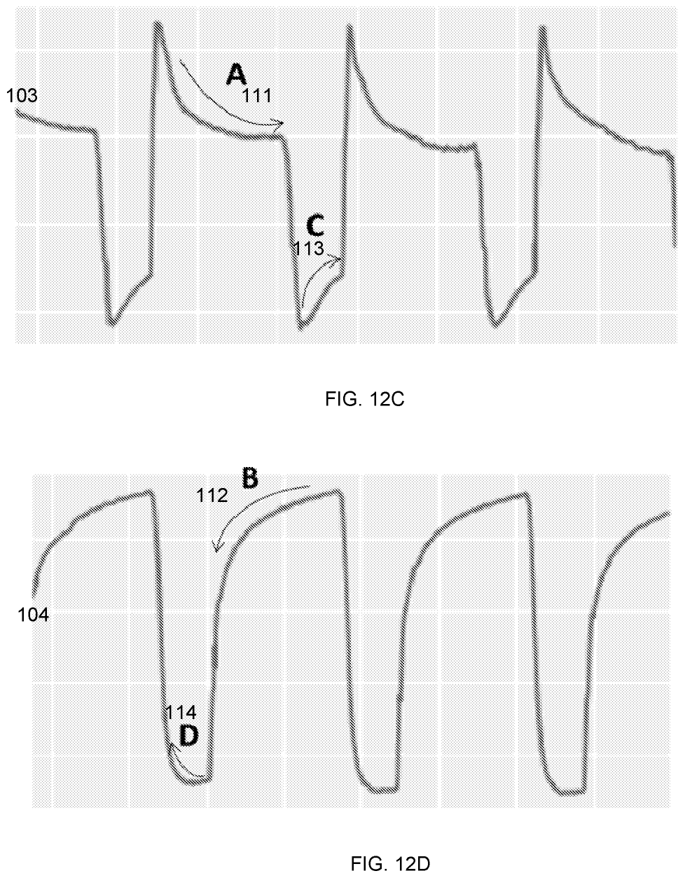

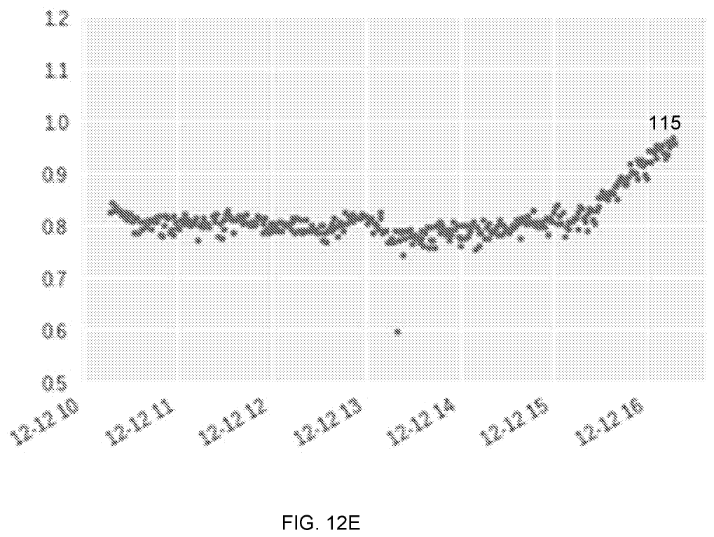

FIG. 12A represent a segment 101 of about fourth open close cycles. For each cycle, the amplitude is calculated. The change of the amplitude as a function of the pinch valve operation time is presented in graph 102 of FIG. 12B.

As can be seen, there is a clear trend and the amplitude monotonously decreasing with increasing operation time. This decrease can be corollate to changes in the flexible tube elasticity.

Different features were extracted for different signal types. The type of the signal is evaluated based on its representative cycle.

By data inspection optional patterns are defined as presented in FIGS. 12C and 12D. For example, the signal in FIG. 12C will corollate well with exponential approximation.

In FIG. 12C a representative signal for nanoparticles based sensors that correlates with exponentials approximation. A 111 represents a relaxation of the rubber in valve close position. C 113 represent a relaxation of the flexible tube in valve open position

The exponential growth factor change as a function of operation time is presented by curve 115 of FIG. 12E. as can be seen, there is a sharp rise in the value about 1 hour before burst. The rise can be attributed to a change in the flexible tube property, that eventually will case burst (e.g., formation of small fractures).

FIG. 12D illustrates a representative signal for nanoparticles based sensors that correlates with logarithmic approximation. B 112 represent a relaxation of the flexible tube in valve close position. D 114 represents a relaxation of the flexible tube in valve open position.

Using approximations (for example logarithmic approximation, exponential approximation or yet another approximation) allows to compress the measurements and save both storage resource, communication resources and the like.

Modelling

The framing of the problem may be a regression one, where the goal is to predict the time remaining until burst of the tube. The general idea is to fit a separate model for each signal type and make an ensemble of them.

A set of eight tubes was used to build the model.

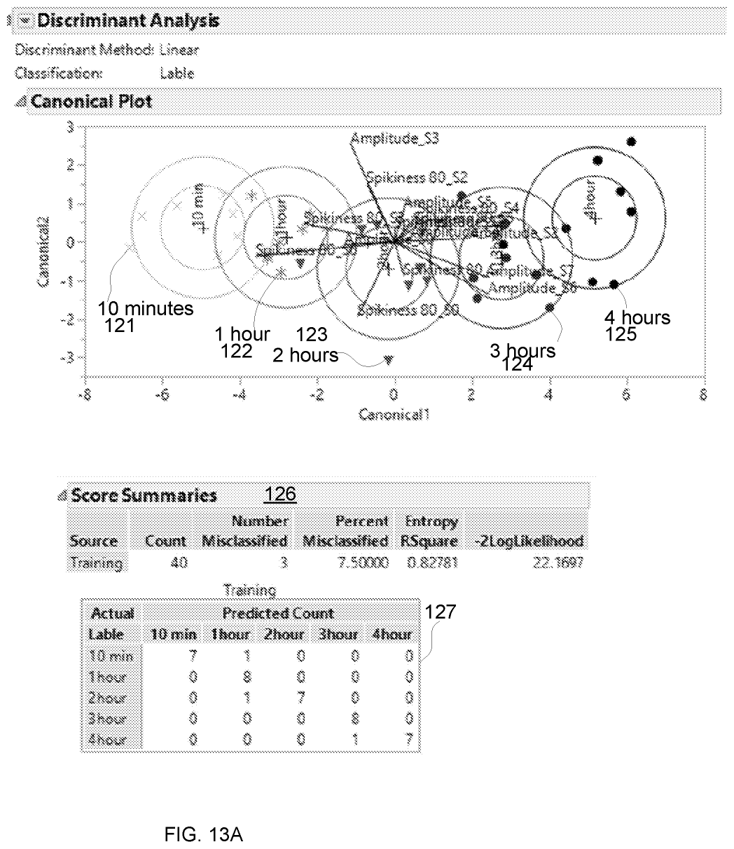

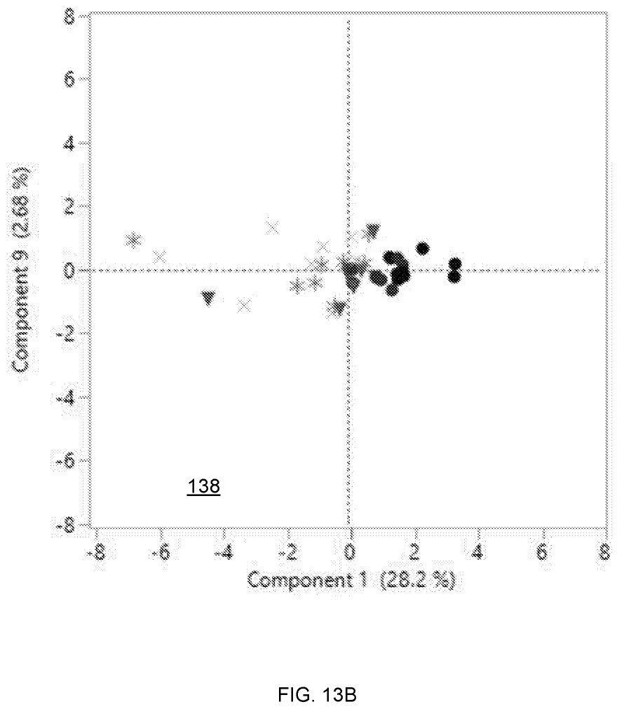

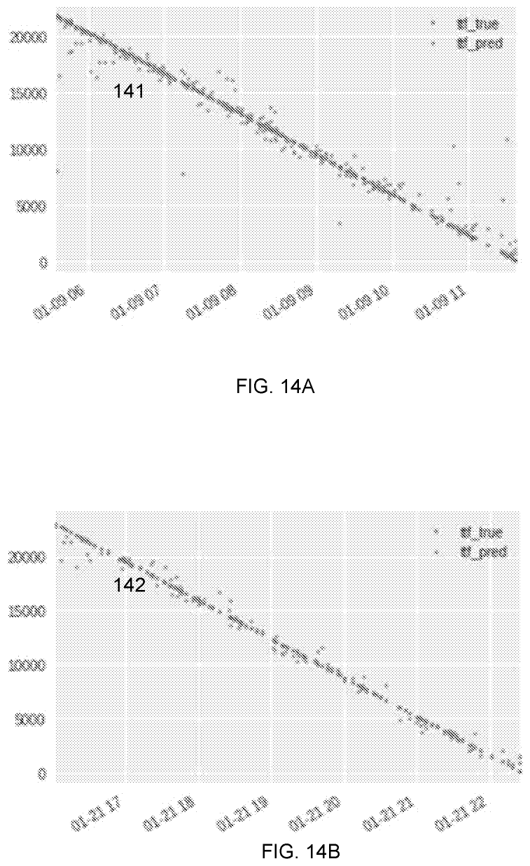

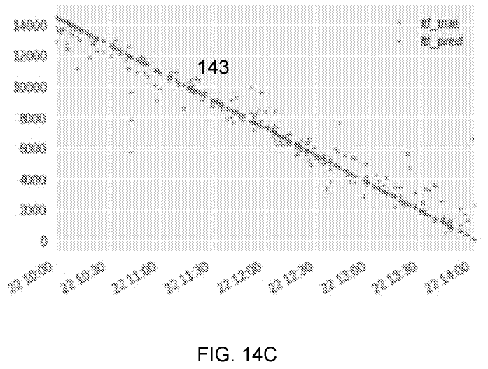

Modelling was based on a subset of the features. Discriminant Analysis and Principle Component Analysis were used to learn about the diversity in the data and the ability to identify failure in the described system (see FIGS. 13A and 13B). Random Forest model was used to predict the bursts (see FIGS. 14A and 14B).

FIG. 13A illustrates a discriminant analysis. It shows a classification of the time to failure in 8 different rubber pinch valve tubes. The data for failure analysis was collected 10 minutes, 1 hour, 2 hours, 3 hours and 4 hours before burst. FIG. 13A illustrates four clusters—first cluster 121 includes measurements taken 10 minutes before failure, second cluster 122 includes measurements taken 1 hour before failure, third cluster 123 includes measurements taken 2 hours before failure, fourth cluster 124 includes measurements taken 3 hours before failure, and fifth cluster 125 includes measurements taken 4 hours before failure.

FIG. 13A also illustrates a score summaries table 126 and a training set 127. The scores are based on discriminated analysis and the data is used as training set. The results imply the system can be trained to predict pinch valve time to failure with 7.5% of missclarifications.

FIG. 13B illustrates Principle Component Analysis—see graph 138. The colors indicate the time to failure as detailed in FIG. 13A. This method deploys combination of features to plot the classified training set with maximum variance.

FIGS. 14A, 14B and 14C include curves 141, 142 and 143 that illustrate the time to failure of three different pinch valve tubes. Blue dots—actual time to failure (ttf true), Green dots—predicted time to failure (ttf_pred) calculated with piezoresistive nanomaterials based sensors adhered to the flexible tube.

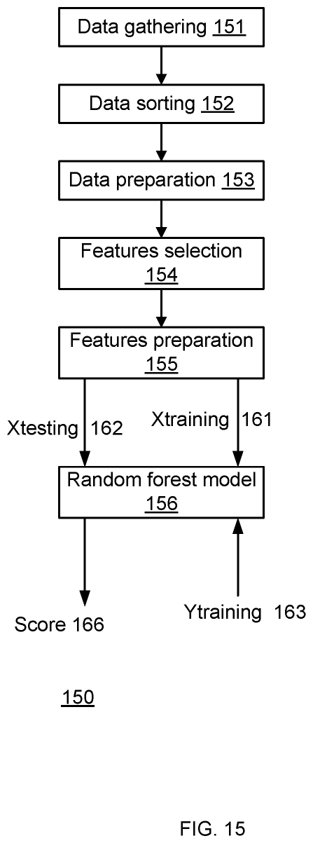

The flow chart of the modeling process 150 is described in FIG. 15.

The modeling process includes the following sequence of steps:
a. Data gathering 151. —the raw data from the flexible sensor is collected and uploaded to the cloud server.
b. Data sorting 152. —the raw data from the flexible sensor is collected and uploaded to the cloud server.
c. Data preparation 153. —the data is processed with the features that were previously defined (derivative, spikiness, linearity etc.)
d. Features selection 154. —the data is processed with the features that were previously defined (derivative, spikiness, linearity etc.)
e. Features preparation 155. —the data is now processed with the features that were previously defined (derivative, spikiness, linearity etc.)
f. Applying a random forest model 156. —the data is now processed with the features that were previously defined (derivative, spikiness, linearity etc.)

The features preparation 155 outputs a training set Xtraining 161 and a test set Xtesting 162.

Xtraining may be based on 70% of the data and used to build features with the real ttf (Ytraining 163) as reference. Xteesting 162—30% of the data is turn into features based on the training set.

From the test set features that are based on the training set, the Ŷ_{prediction} (the predicted time to failure) is received and compered to the actual Y_{testing} which is the real time to failure. The comparison allows to estimate the model accuracy. This model allows the prediction of burst ±150 cycles.

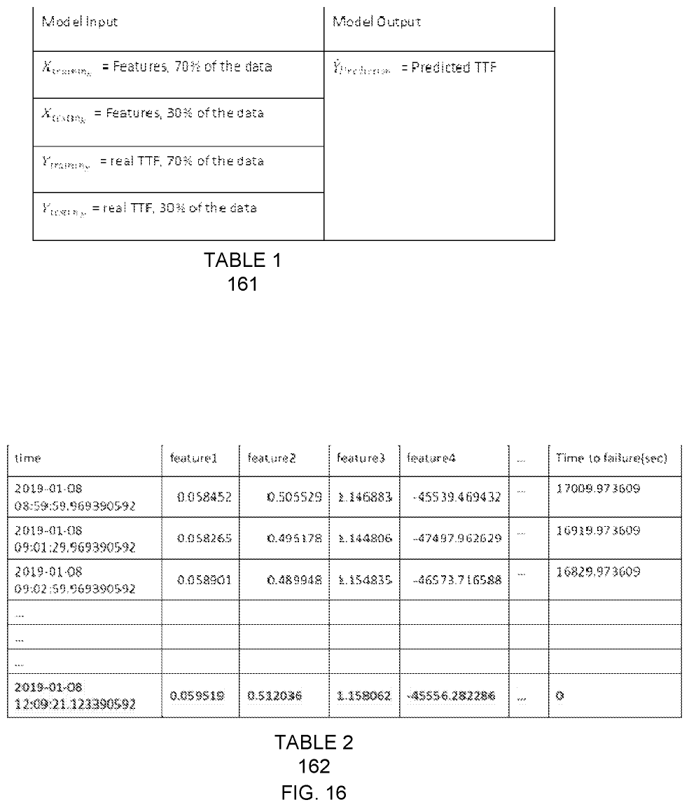

The model inputs and outputs are summarized in Table 1 of FIG. 16. Table 161 provides an example of burst prediction in pinch—inputs and outputs.

Features are sorted alongside the timestamp and the time to failure, creating a new data table. From this point there is no longer use in the raw data. An example of such a table is presented in Table 2 denoted 162 in FIG. 16.

Table 2 provides examples for features list alongside with time stamp and the time to failure.

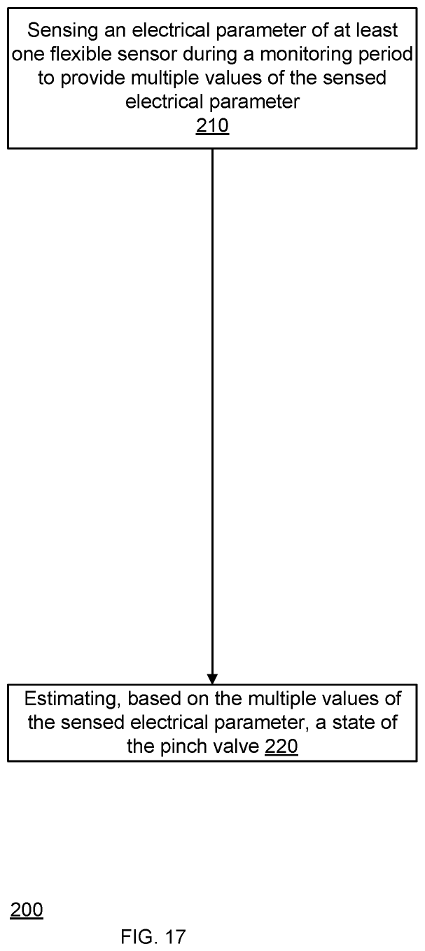

FIG. 17 is an example of a method 200 for monitoring a pinch valve

Method 200 may include steps 210 and 220.

Step 210 may include sensing an electrical parameter of at least one flexible sensor during a monitoring period to provide multiple values of the sensed electrical parameter. The electrical parameter may be conductance, resistance or any other electrical parameter.

The at least one flexible sensor may include piezoresistive nanoparticles.

The piezoresistive nanoparticles may be directly coupled to a flexible conduit of the pinch valve.

The sensed electrical parameter may be indicative of a flexible conduit parameter. The flexible conduit parameter may be stress applied on a part of the flexible conduit to which the flexible sensor is attached, pressure applied on a part of the flexible conduit on which the flexible sensor is attached. Thus—the electrical parameter of the at least one flexible sensor may indicate of a passage of a foreign particle through the flexible conduit, on an expected failure of the flexible conduit, on movements of the flexible conduit, and the like.

The piezoresistive nanoparticles may be imprinted on the flexible conduit of the pinch valve.

The piezoresistive nanoparticles may be printed on at least one flexible substrate that may be glued to the flexible tube of the pinch valve.

Step 210 may be followed by step 220 of estimating, based on the multiple values of the sensed electrical parameter, a state of the pinch valve.

The estimating of the state of the pinch valve may include predicting a failure of the pinch valve.

The predicting of the failure of the pinch valve may include searching for at least one failure pattern, in the multiple values of the sensed electrical parameter, that may be indicative of a future failure of the pinch valve.

The at least one failure pattern may be indicative of a future time of failure.

The predicting of the failure of the pinch valve may include determining at least one pinch valve feature from the multiple values of the sensed electrical parameter and estimating the failure of the pinch valve based on the at least one pinch valve feature.

The estimating may be responsive to changes in one or more elastic properties of the flexible conduit during open close cycles of the pinch valve.

The piezoresistive nanoparticles may be printed on at least one flexible substrate that may be glued to the flexible tube of the pinch valve. The estimating may be responsive to changes in an adhesion of the at least one flexible substrate to the flexible conduit.

The estimating may be responsive to changes in the at least one flexible sensor over time.

The estimate may perform at least one out of calculate a model of, calculate in any other method, estimate, or apply a machine learning process, in order to take into account one or more parameters such as (i) changes in one or more elastic properties of the flexible conduit during open close cycles of the pinch valve, (ii) changes in an adhesion of the at least one flexible substrate to the flexible conduit, (iii) changes in the at least one flexible sensor over time.

The at least one flexible sensor may be multiple flexible sensors.

Some flexible sensors have a favorable sensing direction along a first axis and wherein some other flexible sensors have a favorable sensing direction along a second axis that may be oriented to the first axis.

The first axis may be parallel to a longitudinal axis of the flexible conduit.

The estimating is based on an outcome of a supervised machine learning process.

Any of the numeral examples (for example dimensions, number of cycles, number of sensors, pressure values) and/or materials (rubber, GNP) are non-limiting examples.

Any of the calculations and/or processing and/or estimation may be executed by a processing circuitry. The processing circuitry may be included in each flexible sensor, may be included in an array of flexible sensors, may be located in proximity to the one or more flexible sensor, may be remotely located from the flexible sensors.

The calculations and/or processing may be executed by multiple processing circuitries—for example a compression of the raw sensing signals may be executed by a first processing circuitry while the processing of the compressed data (for example failure prediction) can be executed by another processing circuitry.

The processing circuitry may belong to a measurement device, may be an application-specific integrated circuit (ASIC), a field programmable gate array (FPGA), a graphic processing unit (GPU), a central processing unit (CPU), a hardware accelerator, a customized circuit, and the like.

There may be provided a kit that may include a pinch valve; and at least one flexible sensor that comprises piezoresistive nanomaterials, wherein the piezoresistive nanomaterials may be directly coupled to a flexible conduit of the pinch valve.

The piezoresistive nanomaterials may be imprinted on the flexible conduit of the pinch valve.

The piezoresistive nanomaterials may be printed on at least one flexible substrate that may be glued to the flexible tube of the pinch valve.

The at least one flexible sensor may be multiple flexible sensors.

The kit wherein some flexible sensors have a favorable sensing direction along a first axis and wherein some other flexible sensors have a favorable sensing direction along a second axis that may be oriented to the first axis.

The first axis may be parallel to a longitudinal axis of the flexible conduit.

The kit may include a computer readable medium that stores instructions for: (a) receiving multiple values of a sensed electrical parameter of the at least one flexible sensor; wherein the sensed electrical parameter may be indicative of a flexible conduit parameter selected out of stress and pressure; and (b) estimating, based on the multiple values of the sensed electrical parameter, a state of the pinch valve.

There may be provided a non-transitory computer readable medium that stores instructions for receiving a sensed electrical parameter of at least one flexible sensor during a monitoring period to provide multiple values of the sensed electrical parameter; wherein the at least one flexible sensor comprises piezoresistive nanomaterials, wherein the piezoresistive nanomaterials are directly coupled to a flexible conduit of the pinch valve; wherein the sensed electrical parameter is indicative of a flexible conduit parameter selected out of stress and pressure; and estimating, based on the multiple values of the sensed electrical parameter, a state of the pinch valve.

The non-transitory computer readable medium may be a memory unit, an integrated circuit with storage capabilities, a compact disk, a magnetically readable media, a electrically readable media, a optically readable media, and the like.

Any reference to any of the terms “comprise”, “comprises”, “comprising” “including”, “may include” and “includes” may be applied to any of the terms “consists”, “consisting”, “and consisting essentially of”. For example—any of figures describing masks used for implementing a device may include more components that those illustrated in the figure, only the components illustrated in the figure or substantially only the components illustrate in the figure.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between elements are merely illustrative and that alternative embodiments may merge elements or impose an alternate decomposition of functionality upon various elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single device. Alternatively, the examples may be implemented as any number of separate devices or separate devices interconnected with each other in a suitable manner. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art.

It is, therefore, to be understood that the appended claims are intended to cover all such modifications and changes as fall within the true spirit of the invention.

Any reference to a method may be applied mutatis mutandis to a non-transitory computer readable medium that stores instructions for executing the method. The non-transitory computer readable medium may be an integrated circuit, a part of an integrated circuit, a memory unit, a compact disk, an optical storage medium, a magnetic storage medium, a memristive storage medium, a capacitive based storage medium, and the like.

1. A method for monitoring a pinch valve, the method comprises:
sensing an electrical parameter of at least one flexible sensor during a monitoring period to provide multiple values of the sensed electrical parameter; wherein the at least one flexible sensor comprises piezoresistive nanomaterials, wherein the piezoresistive nanomaterials are directly coupled to a flexible conduit of the pinch valve; wherein the sensed electrical parameter is indicative of a flexible conduit parameter selected out of stress and pressure; and
estimating, based on the multiple values of the sensed electrical parameter, a state of the pinch valve.

2. The method according to claim 1 wherein the piezoresistive nanomaterials are imprinted on the flexible conduit of the pinch valve or wherein the piezoresistive nanomaterials are printed on at least one flexible substrate that is glued to the flexible tube of the pinch valve.

3. (canceled)

4. The method according to claim 1 wherein the estimating of the state of the pinch valve comprises predicting a failure of the pinch valve.

5. The method according to claim 4 wherein the predicting of the failure of the pinch valve comprises searching for at least one failure pattern, in the multiple values of the sensed electrical parameter, that is indicative of a future failure of the pinch valve.

6. (canceled)

7. The method according to claim 4 wherein the predicting of the failure of the pinch valve comprises determining at least one pinch valve feature from the multiple values of the sensed electrical parameter and estimating the failure of the pinch valve based on the at least one pinch valve feature.

8. (canceled)

9. The method according to claim 1 wherein the piezoresistive nanomaterials are printed on at least one flexible substrate that is glued to the flexible tube of the pinch valve; and wherein the estimating is responsive to changes in an adhesion of the at least one flexible substrate to the flexible conduit.

10. The method according to claim 1 wherein the estimating is responsive to changes in the at least one flexible sensor over time.

11. The method according to claim 1 wherein the at least one flexible sensor is multiple flexible sensors, wherein some flexible sensors have a favorable sensing direction along a first axis and some other flexible sensors have a favorable sensing direction along a second axis that is oriented to the first axis, and wherein the first axis is parallel to a longitudinal axis of the flexible conduit.

12-13. (canceled)

14. The method according to claim 1 wherein the estimating is based on an outcome of a supervised machine learning process.

15. The method according to claim 1 wherein the estimating of the state of the pinch valve comprises sensing a passage of a foreign particle through the pinch valve.

16. A kit comprising: a pinch valve; and at least one flexible sensor that comprises piezoresistive nanomaterials, wherein the piezoresistive nanomaterials are directly coupled to a flexible conduit of the pinch valve.

17. The kit according to claim 16 wherein the piezoresistive nanomaterials are imprinted on the flexible conduit of the pinch valve or wherein the piezoresistive nanomaterials are printed on at least one flexible substrate that is glued to the flexible tube of the pinch valve.

18. (canceled)

19. The kit according to claim 16 wherein the at least one flexible sensor is multiple flexible sensors, wherein the piezoresistive nanomaterials are printed on at least one flexible substrate that is glued to the flexible tube of the pinch valve, and wherein the first axis is parallel to a longitudinal axis of the flexible conduit.

20-21. (canceled)

22. The kit according to claim 16 further comprising a computer readable medium that stores instructions for: (a) receiving multiple values of a sensed electrical parameter of the at least one flexible sensor; wherein the sensed electrical parameter is indicative of a flexible conduit parameter selected out of stress and pressure; and (b) estimating, based on the multiple values of the sensed electrical parameter, a state of the pinch valve.

23. A non-transitory computer readable medium that stores instructions for:
receiving a sensed electrical parameter of at least one flexible sensor during a monitoring period to provide multiple values of the sensed electrical parameter; wherein the at least one flexible sensor comprises piezoresistive nanomaterials, wherein the piezoresistive nanomaterials are directly coupled to a flexible conduit of the pinch valve; wherein the sensed electrical parameter is indicative of a flexible conduit parameter selected out of stress and pressure; and
estimating, based on the multiple values of the sensed electrical parameter, a state of the pinch valve.

24-25. (canceled)

26. The non-transitory computer readable medium according to claim 23 wherein the estimating of the state of the pinch valve comprises predicting a failure of the pinch valve.

27. The non-transitory computer readable medium according to claim 26 wherein the predicting of the failure of the pinch valve comprises searching for at least one failure pattern, in the multiple values of the sensed electrical parameter, that is indicative of a future failure of the pinch valve.

28. (canceled)

29. The non-transitory computer readable medium according to claim 26 wherein the predicting of the failure of the pinch valve comprises determining at least one pinch valve feature from the multiple values of the sensed electrical parameter and estimating the failure of the pinch valve based on the at least one pinch valve feature.

30. The non-transitory computer readable medium according to claim 23 wherein the estimating is responsive to changes in one or more elastic properties of the flexible conduit during open close cycles of the pinch valve, wherein the estimating is responsive to changes in the at least one flexible sensor over time, or wherein the estimating of the state of the pinch valve comprises sensing a passage of a foreign particle through the pinch valve.

31-35. (canceled)

36. The non-transitory computer readable medium according to claim 23 wherein the estimating is based on an outcome of a supervised machine learning process.

37. (canceled)
